(19) United States
(12) Patent Application Publication
(10) Pub. No.: US 2026/0088700 A1
(43) Pub. Date: Mar. 26, 2026

(54) METHOD FOR PERFORMING DISCONTINUOUS CONDUCTION MODE PULSE CONTROL OF BUCK CONVERTER TO REDUCE INDUCTOR LOSS, AND ASSOCIATED APPARATUS

(71) Applicant: MEDIATEK INC., Hsinchu City (TW)

(72) Inventors: Chih-Chen Li, Hsinchu City (TW); Meng-Hsiu Chang, Hsinchu City (TW); Chun-Chieh Tseng, Hsinchu City (TW)

(73) Assignee: MEDIATEK INC., Hsinchu City (TW)

(21) Appl. No.: 19/334,996

(22) Filed: Sep. 22, 2025

Related U.S. Application Data
(60) Provisional application No. 63/698,078, filed on Sep. 24, 2024.

(51) Int. Cl. H02M 1/00; H02M 3/158

(52) U.S. Cl. CPC H02M 1/0048; H02M 3/158

(57) ABSTRACT

A method for performing discontinuous conduction mode (DCM) pulse control of a buck converter to reduce inductor loss and an associated apparatus are provided. The method may include: performing multi-pulse control on the buck converter to make the bulk converter operate in a DCM; and during performing the multi-pulse control on the buck converter to make the bulk converter operate in the DCM, generating multiple pulses per period to increase and then decrease an inductor current of an inductor within the bulk converter for more than one iteration, in order to reduce the inductor loss.

### CROSS REFERENCE TO RELATED APPLICATIONS

This application claims the benefit of U.S. Provisional Application No. 63/698,078, filed on Sep. 24, 2024. The content of the application is incorporated herein by reference.

### BACKGROUND

The present invention is related to direct current (DC)-to-DC converter design, and more particularly, to a method for performing discontinuous conduction mode (DCM) pulse control of a buck converter to reduce inductor loss, and an associated apparatus.

According to the related art, a buck converter is a DC-to-DC converter used for converting a high voltage to a low voltage, and in any buck converter among the buck converters that are available on the market, the power efficiency (PE) at a light load is mainly affected by inductor losses. For example, the inductor losses typically comprise the copper loss (which may be referred to as the Direct Current Resistance loss, or “the DCR” for brevity) and the core loss, and the core loss in inductors is primarily caused by an alternating magnetic field in the core material. As the core loss is dependent on the operating frequency and the total magnetic flux swing, it may vary between different magnetic materials. In addition, the core loss is typically not included in the Simulation Program with Integrated Circuit Emphasis (SPICE) model provided by inductor vendors, and it can vary significantly among different vendors even for the same inductance rating value, thereby impacting the buck converter power efficiency. Thus, a novel method and associated architecture are needed for solving the problems without introducing any side effect or in a way that is less likely to introduce a side effect.

### SUMMARY

It is an objective of the present invention to provide a method for performing DCM pulse control of a buck converter (or “step-down converter”) to reduce inductor loss, and an associated apparatus, in order to solve the above-mentioned problems.

At least one embodiment of the present invention provides a method for performing DCM pulse control of a buck converter to reduce inductor loss. For example, the method may comprise: performing multi-pulse control on the buck converter to make the bulk converter operate in a DCM; and during performing the multi-pulse control on the buck converter to make the bulk converter operate in the DCM, generating multiple pulses per period to increase and then decrease an inductor current of an inductor within the bulk converter for more than one iteration, in order to reduce the inductor loss.

At least one embodiment of the present invention provides an apparatus for performing DCM pulse control of a buck converter to reduce inductor loss, where the apparatus may comprise a multi-pulse control circuit, and the multi-pulse control circuit may be arranged to perform multi-pulse control on the buck converter to make the bulk converter operate in a DCM. For example, during performing the multi-pulse control on the buck converter to make the bulk converter operate in the DCM, the multi-pulse control circuit may be arranged to generate multiple pulses per period to increase and then decrease an inductor current of an inductor within the bulk converter for more than one iteration, in order to reduce the inductor loss.

According to some embodiments, the apparatus may comprise at least one portion (e.g., one or more portions) of the buck converter. For example, the apparatus may comprise the multi-pulse control circuit mentioned above. In another example, the apparatus may comprise the multi-pulse control circuit and a driver circuit (or “the driver”) of the buck converter. In some examples, the apparatus may comprise the buck converter, and the multi-pulse control circuit is integrated into the buck converter.

It is an advantage of the present invention that, the method of the present invention, as well as the associated apparatus such as the multi-pulse control circuit, can perform the multi-pulse control for achieving the power saving, in particular, as the reduction in the core loss exceeds the increase in the on/off switching loss of the device. In addition, the method of the present invention and the associated apparatus such as the multi-pulse control circuit can solve the problems in the related art without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates, in the lower half part thereof, a multi-pulse control scheme of a method for performing DCM pulse control of a buck converter to reduce inductor loss according to an embodiment of the present invention, where a single-pulse control scheme of the buck converter is illustrated in the upper half part of FIG. 1 for better comprehension.

FIG. 2 illustrates an inductor current involved with the multi-pulse control scheme shown in FIG. 1, such as the inductor current having periodic partial curves corresponding to multiple periods, according to an embodiment of the present invention.

FIG. 3 is a diagram illustrating an apparatus for performing DCM pulse control of a buck converter to reduce inductor loss, where a multi-pulse control circuit operating according to the method may be integrated into the buck converter.

FIG. 4 is a diagram illustrating associated signals of the buck converter shown in FIG. 3 according to an embodiment of the present invention.

FIG. 5 is a diagram illustrating associated parameters of the multi-pulse control circuit shown in FIG. 3 according to an embodiment of the present invention.

FIG. 6 is a diagram illustrating multiple sub-circuits of the multi-pulse control circuit shown in FIG. 3 as well as associated operations of the multiple sub-circuits according to an embodiment of the present invention.

FIG. 7 is a diagram illustrating a peak and valley timing control scheme of the method according to an embodiment of the present invention.

FIG. 8 is a diagram illustrating some implementation details of the peak and valley timing control scheme shown in FIG. 8 according to an embodiment of the present invention.

FIG. 9 is a flowchart of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

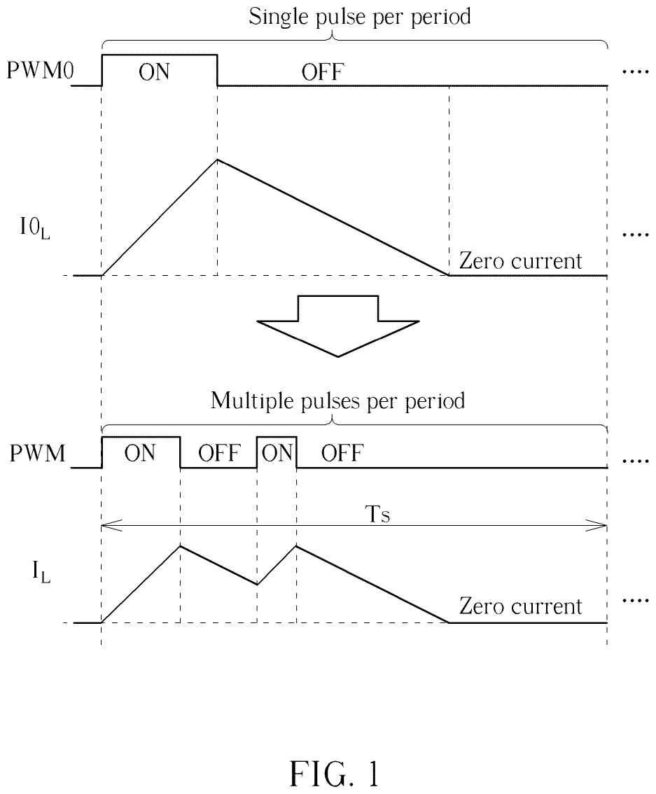

FIG. 1 illustrates, in the lower half part thereof, a multi-pulse control scheme of a method for performing DCM pulse control of a buck converter to reduce inductor loss according to an embodiment of the present invention, where a single-pulse control scheme of the buck converter is illustrated in the upper half part of FIG. 1 for better comprehension. Assume that one or more functions of the buck converter may be temporarily disabled to allow the buck converter to operate according to the single-pulse control scheme shown in the upper half part of FIG. 1, but the present invention is not limited thereto. Based on the single-pulse control scheme, the buck converter may be arranged to generate a single pulse per period on a control signal PWM0 (e.g., an ordinary pulse-width modulation signal having one pulse per period) for controlling the bulk converter, in order to make an inductor current I0_{L} of an inductor within the bulk converter increase and then decrease just once per period before reaching a zero current (e.g., an inductor current value which is equal to zero).

As shown in the lower half part of FIG. 1, the buck converter can operate according to the multi-pulse control scheme to perform multi-pulse control on the buck converter to make the bulk converter operate in a DCM, for achieving power saving, and more particularly, during performing the multi-pulse control on the buck converter to make the bulk converter operate in the DCM, generate multiple pulses per period at the driving stage such as a driver circuit under the control of a control signal PWM (e.g., an extraordinary pulse-width modulation signal having more than one pulse per period) for controlling the bulk converter, to increase and then decrease an inductor current I_{L} of the inductor within the bulk converter for more than one iteration per period (e.g., the period Ts) before reaching the zero current (e.g., the inductor current value which is equal to zero), in order to reduce the inductor loss, and therefore achieve a better overall performance.

For better comprehension, the “PWM” of the symbol “PWM0” of the control signal PWM0 stands for pulse-width modulation, indicating that the control signal PWM0 is a pulse-width modulation signal such as the ordinary pulse-width modulation signal mentioned above, and the symbol “PWM” of the control signal PWM stands for pulse-width modulation, indicating that the control signal PWM is a pulse-width modulation signal such as the extraordinary pulse-width modulation signal mentioned above.

According to some embodiments, the buck converter (or a control circuit therein operating according to the method) can reduce the core loss by effectively controlling the DCM pulses, and can precisely regulate the valley level of the DCM pulses and facilitate the production of the multiple pulses in the DCM. The core loss in the inductor can be reduced by decreasing the Root Mean Square (RMS) current (IRMS) of an inductor current (which may also be referred to as “the RMS current I_{RMS}” for brevity) and the switching frequency Fsw. For example, the associated operations of multiple sub-methods #1, #2 and #3 (or “Methods 1, 2 and 3” for brevity) within the method may comprise:
Method 1: Reducing the DCM pulse peak current by implementing the multi-pulse control, where reducing the DCM pulse peak current will lead to a reduction in the RMS current I_{RMS};
Method 2: Utilizing the multi-pulse control to accurately regulate peak and valley levels while maintaining or increasing the charge in the inductor, for example, this configuration allows for a reduction in the switching frequency Fsw, where Fsw=(1/Ts) and “Ts” represents the occurrence period of the multi-pulse/double-peak (or “the multi-pulse/double-peak occurrence period”), such as the occurrence period of the multiple pulses and/or the double peaks corresponding to the multiple pulses in the multi-pulse control scheme; and
Method 3: Effectively managing the device on/off switching loss in the buck converter, such as the on/off switching loss of at least one switching device within the buck converter, where the device such as the aforementioned at least one switching device can be implemented as a Metal Oxide Semiconductor Field Effect Transistor (MOSFET) such as a P-type MOSFET (or “PMOS” for brevity), an N-type MOSFET (or “NMOS” for brevity), or both.

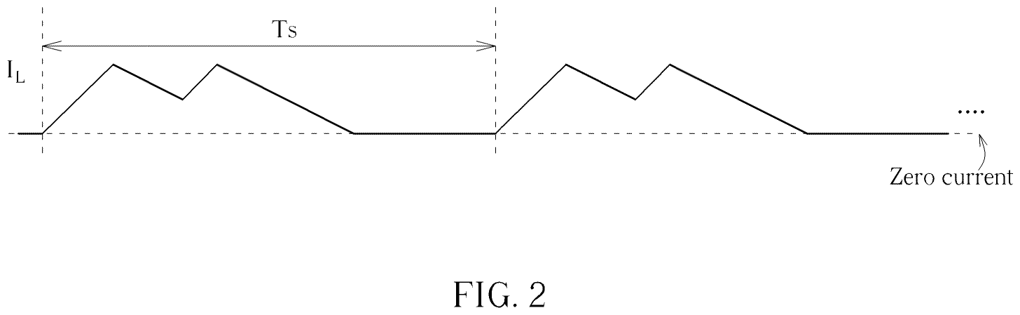

FIG. 2 illustrates an inductor current involved with the multi-pulse control scheme shown in FIG. 1, such as the inductor current I_{L} having periodic partial curves corresponding to multiple periods, according to an embodiment of the present invention. The buck converter (or the control circuit therein) can achieve power savings as the combined reduction in the core loss from the sub-method #1 (or “Method 1”) and the sub-method #2 (or “Method 2”) exceeds the increase in the on/off switching loss of the aforementioned at least one switching device (e.g., the PMOS and the NMOS) in the buck converter due to the multi-pulse control.

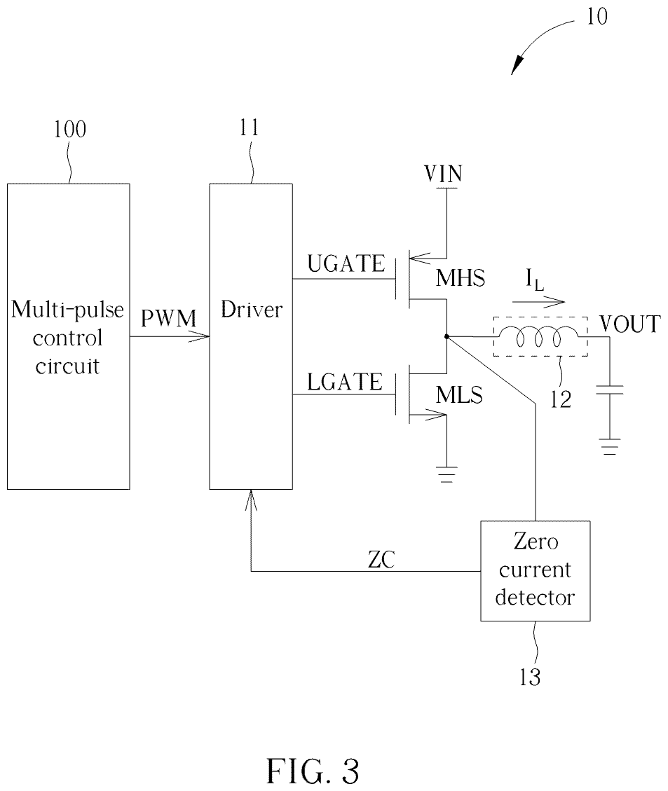

FIG. 3 is a diagram illustrating an apparatus for performing DCM pulse control of a buck converter 10 to reduce inductor loss, where the apparatus may comprise at least one portion (e.g., one or more portions) of the buck converter 10, such as a multi-pulse control circuit 100 operating according to the method. More particularly, the apparatus may comprise the buck converter 10, and the multi-pulse control circuit 100 operating according to the method may be integrated into the buck converter 10. As shown in FIG. 3, the buck converter 10 comprises the multi-pulse control circuit 100, a driver circuit 11 (or “the driver 11” for brevity), and an output stage circuit coming after the driver 11, and the output stage circuit comprises the aforementioned at least one switching device such as multiple switching devices MHS and MLS, the aforementioned inductor such as an inductor 12, a zero current detector 13, and a capacitor coupled to the inductor 12. The multi-pulse control circuit 100 can be arranged to perform the multi-pulse control mentioned above, the driver 11 can be arranged to drive the output stage circuit under control of the control signal PWM from the multi-pulse control circuit 100, and the output stage circuit can be arranged to convert an input voltage VIN of the buck converter 10 into an output voltage VOUT of the buck converter 10. For example, the multiple switching devices MHS and MLS can be implemented as MOSFETs such as a P-type MOSFET (or “the PMOS”) and an N-type MOSFET (or “the NMOS”), respectively, and the driver 11 can be equipped with logic circuits such as output logic circuits (or “the OUTLGC” for brevity) for generating multiple gate control signals UGATE and LGATE according to the control signal PWM, allowing the driver 11 to control the multiple switching devices MHS and MLS with the gate control signals UGATE and LGATE, respectively, to operate in accordance with the control signal PWM from the multi-pulse control circuit 100 as well as a zero current detection result ZC from the zero current detector 13. The zero current detector 13 can detect whether the inductor current I_{L} of the inductor 12 is equal to the zero current mentioned above, in order to generate the zero current detection result ZC for indicating whether the inductor current I_{L} reaches the zero current. For better comprehension, the buck converter 10 and the multi-pulse control circuit 100 can be taken as examples of the aforementioned buck converter and the control circuit therein in the previous embodiments, respectively, but the present invention is not limited thereto. According to some embodiments, the architecture of the buck converter 10 and/or the multi-pulse control circuit 100 may vary. For example, both of the multiple switching devices MHS and MLS can be implemented as N-type MOSFETs.

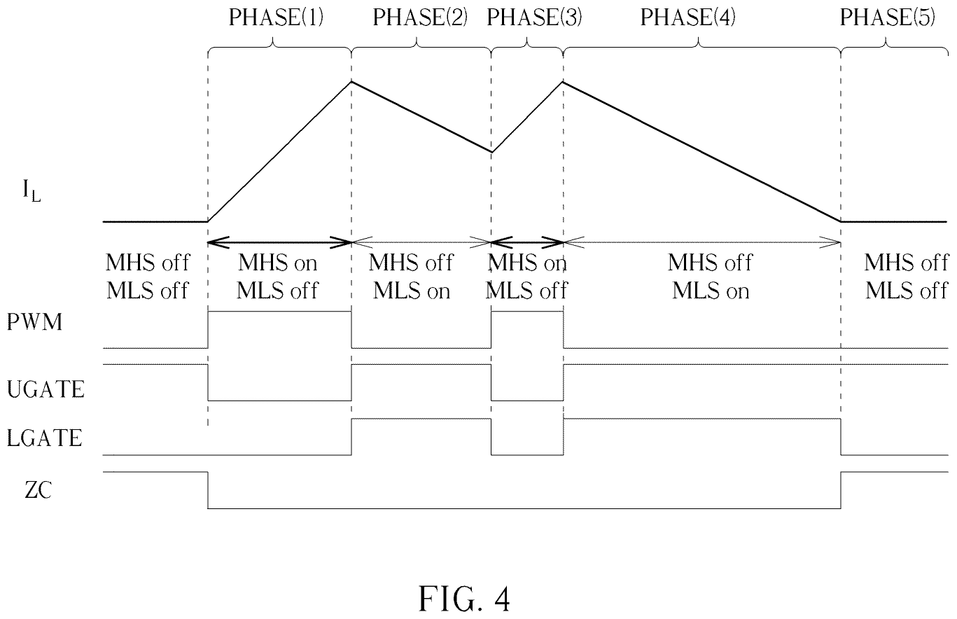

FIG. 4 is a diagram illustrating associated signals of the buck converter 10 shown in FIG. 3 according to an embodiment of the present invention. The buck converter 10 (or the multi-pulse control circuit 100 therein) can be arranged to perform the multi-pulse control on the buck converter 10 to make the bulk converter 10 operate in the DCM, for achieving the power saving as the reduction in the core loss exceeds the increase in the on/off switching loss of the aforementioned at least one switching device (e.g., the multiple switching devices MHS and MLS) within the buck converter 10. As shown in FIG. 4, in any period among multiple periods of the inductor current I_{L}, the inductor current I_{L} comprises a controllable inductor current valley and two identical inductor current peaks, which can be referred to as “the controllable I_{L} valley” and “the two identical I_{L} peaks” for brevity, respectively. For example, the controllable inductor current valley (or “the I_{L} valley”) can be equal to or greater than zero but smaller than any inductor current peak (or “the I_{L} peak”) among the two identical inductor current peaks. With the controllable inductor current valley (or “the controllable I_{L} valley”) and the two identical inductor current peaks (or “the two identical I_{L} peaks”), the multi-pulse control can more effectively control the ratio of the core loss and the switching loss of the buck converter 10 (or the switching device(s) therein such as the switching devices MHS and MLS), thereby achieving optimal conversion efficiency. This is for illustrative purposes only, and is not meant to be a limitation of the present invention. According to some embodiments, in the aforementioned any period among the multiple periods of the inductor current I_{L}, the inductor current I_{L} may comprise at least two inductor current peaks and at least one inductor current valley, where the two identical inductor current peaks may represent any two inductor current peaks among the aforementioned at least two inductor current peaks, and the controllable inductor current valley may represent an inductor current valley between the aforementioned any two inductor current peaks. In some embodiments, all inductor current peaks among the aforementioned at least two inductor current peaks are identical to each other, and the inductor current valley between the aforementioned any two inductor current peaks is greater than zero, and is less than the aforementioned any two inductor current peaks. In some embodiments, an inductor current valley between the any two inductor current peaks is greater than zero, and is less than any inductor current peak in the at least two inductor current peaks.

The multi-pulse control circuit 100 can generate at least one control signal (e.g., one or more control signals) such as the control signal PWM. When the buck converter 10 needs to source the load current, in particular, obtain the load current from a source which provides the input voltage VIN, the multi-pulse control circuit 100 can generate the control signal PWM to the driver 11 to cause the driver 11 to generate the gate control signal UGATE for controlling the switching device MHS and the gate control signal LGATE for controlling the switching device MLS. The gate control signals UGATE and LGATE are used for controlling the switching devices MHS and MLS, so that a current waveform of the inductor 12 in the buck converter 10 is a waveform with multiple peaks.

TABLE 1

| Phase | PHASE(1) | PHASE(2) | PHASE(3) | PHASE(4) | PHASE(5) |
|---|---|---|---|---|---|
| MHS | On | Off | On | Off | Off |
| MLS | Off | On | Off | On | Off |

Table 1 illustrates an example of multiple phases {PHASE(1), PHASE(2), PHASE(3), PHASE(4), PHASE(5)} of one period Ts as well as the turn-on/turn-off states (or “the on/off states”) of the switching devices MHS and MLS in the multiple phases {PHASE(1), PHASE(2), PHASE(3), PHASE(4), PHASE(5)}. For better comprehension, the turn-off states of the switching devices MHS and MLS are labeled “MHS off” and “MLS off” in FIG. 4, respectively, and the turn-on states of the switching devices MHS and MLS are labeled “MHS on” and “MLS on” in FIG. 4, respectively. The multi-pulse control circuit 100 can control the driver 11 via the control signal PWM to turn on/off the switching devices MHS and MLS in the multiple phases {PHASE(1), PHASE(2), PHASE(3), PHASE(4), PHASE(5)} of the period Ts. By using the multi-pulse control circuit 100 to control the switching of the switching devices MHS and MLS (e.g., the PMOS and the NMOS as shown in FIG. 3, respectively, for the case of using different types of transistors, or one NMOS and another NMOS, respectively, for the case of using the same type of transistors) in the buck converter 10, the inductor current I_{L} can exhibit a waveform with multiple peaks. More implementation details regarding the multi-pulse control circuit 100 will be described with reference to the subsequent figures.

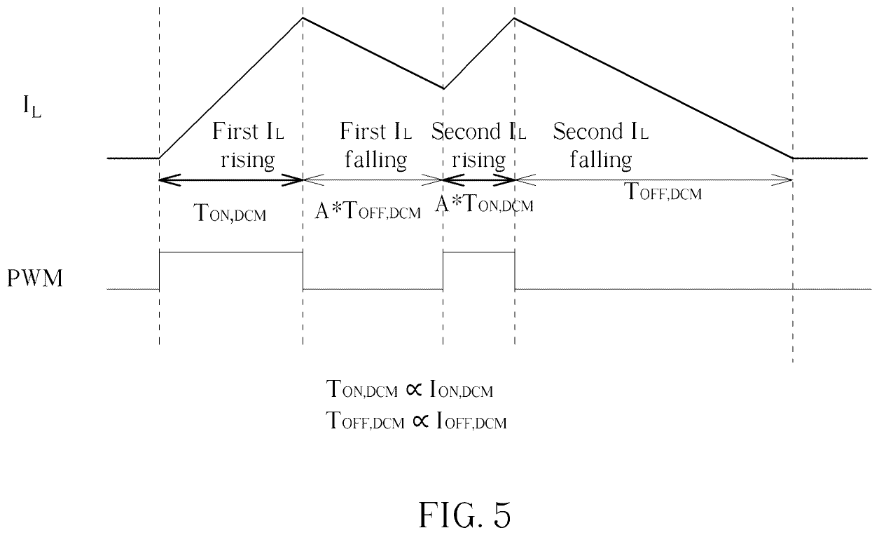

FIG. 5 is a diagram illustrating associated parameters of the multi-pulse control circuit 100 shown in FIG. 3 according to an embodiment of the present invention, where the rising/falling of the inductor current I_{L} can be referred to as the inductor current I_{L}'S rising/falling, or the I_{L} rising/falling for brevity. The buck converter 10 (or the multi-pulse control circuit 100 therein) can control the lengths of time (or “the time lengths”) of the phases PHASE(1), PHASE(2), PHASE(3) and PHASE(4) respectively corresponding to the first I_{L} rising, the first I_{L} falling, the second I_{L} rising and the second I_{L} falling, such as the first inductor-current rising time (T_{ON,DCM}), the first inductor-current falling time (A*T_{OFF,DCM}), the second inductor-current rising time (A*T_{ON,DCM}) and the second inductor-current falling time (T_{OFF,DCM}), respectively referred to as the first I_{L} rising time (T_{ON,DCM}), the first I_{L} falling time (A*T_{OFF,DCM}), the second I_{L} rising time (A*T_{ON,DCM}) and the second I_{L} falling time (T_{OFF,DCM}) hereinafter, as well as the current I_{ON,DCM} and the current I_{OFF,DCM}, where the first I_{L} rising time (T_{ON,DCM}) is proportional to the current I_{ON,DCM} (labeled “T_{ON,DCM}∝I_{ON,DCM}” for brevity), and the second I_{L} falling time (T_{OFF,DCM}) is proportional to the current I_{OFF,DCM} (labeled “T_{OFF,DCM}∝I_{OFF,DCM}” for brevity).

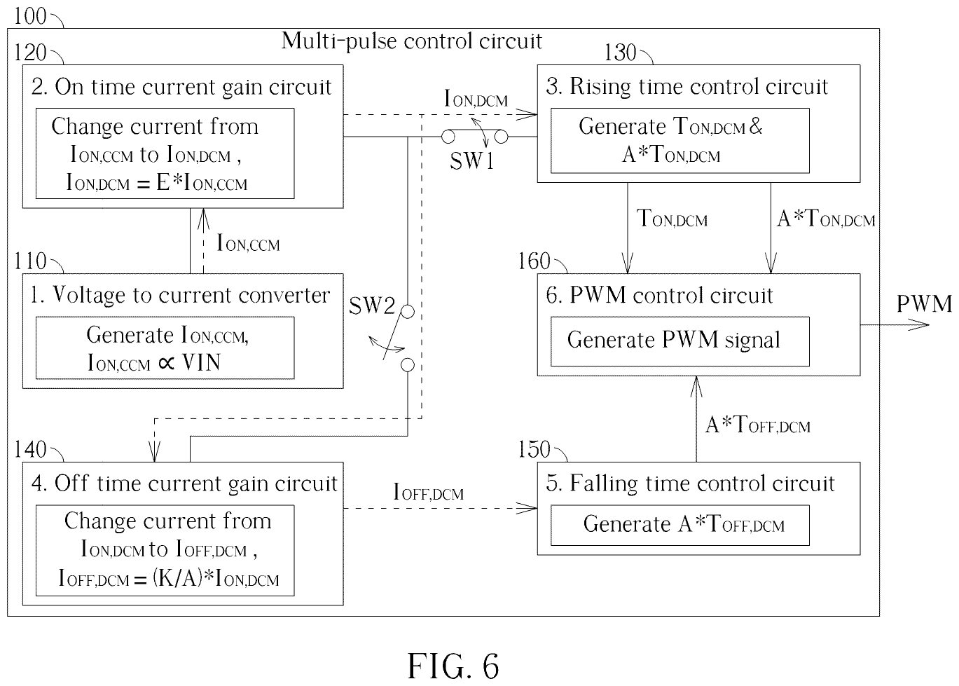

FIG. 6 is a diagram illustrating multiple sub-circuits of the multi-pulse control circuit 100 shown in FIG. 3 as well as associated operations of the multiple sub-circuits according to an embodiment of the present invention. The multiple sub-circuits of the multi-pulse control circuit 100 may comprise multiple blocks #1, #2, #3, #4, #5 and #6 (or “Blocks 1, 2, 3, 4, 5 and 6” for brevity) which can be implemented as follows:
Block 1: the voltage to current converter 110, arranged to generate the current I_{ON,CCM} which can involve the VIN information such as the information (e.g., the voltage level) of the input voltage VIN, for example, the voltage to current converter 110 can perform voltage to current conversion on the input voltage VIN to generate the current I_{ON,CCM}, with the current I_{ON,CCM} being proportional to the input voltage VIN (labeled “I_{ON,CCM}∝VIN” for brevity), where the input voltage VIN means a supply voltage of the buck converter 10;
Block 2: the on time current gain circuit 120, arranged to adjust the I_{ON,DCM} gain (which can be regarded as the on time current gain controlled by the on time current gain circuit 120), for example, the on time current gain circuit 120 can change the current in accordance with the equation, I_{ON,DCM}=(E*I_{ON,CCM}), to convert the current I_{ON,CCM} into the current I_{ON,DCM}, where the on time current gain can be implemented as the on time current ratio E in this equation, I_{ON,DCM}=(E*I_{ON,CCM}), and the on time current ratio E can be equal to a first predetermined value such as a first positive value, for example, the on-time current ratio E may be set based on an ideal efficiency of the buck converter;
Block 3: the rising time control circuit 130, arranged to control the first I_{L} rising time (T_{ON,DCM}) and the second I_{L} rising time (A*T_{ON,DCM}) of the waveform, for example, the rising time control circuit 130 can generate the first I_{L} rising time (T_{ON,DCM}) and the second I_{L} rising time (A*T_{ON,DCM}), with both of the first I_{L} rising time (T_{ON,DCM}) and the second I_{L} rising time (A*T_{ON,DCM}) being proportional to the current I_{ON,DCM}, and more particularly, control one first-level time period and another first-level time period of a first level (e.g., a high level) of the control signal PWM, respectively, for controlling the first I_{L} rising time (T_{ON,DCM}) and the second I_{L} rising time (A*T_{ON,DCM}) of the waveform of the inductor current I_{L}, respectively, where “A” can be equal to a second predetermined value such as a second positive value;
Block 4: the off time current gain circuit 140, arranged to adjust the I_{OFF,DCM} gain (which can be regarded as the off time current gain controlled by the off time current gain circuit 140), for example, the off time current gain circuit 140 can change the current in accordance with the equation, I_{OFF,DCM}=((K/A)*I_{ON,DCM}), to convert the current I_{ON,DCM} into the current I_{OFF,DCM}, where the off time current gain can be implemented as the off time current ratio (K/A) in this equation, I_{OFF,DCM}=((K/A)*I_{ON,DCM}), “K” is an arbitrary constant, and the arbitrary constant K can be equal to a third predetermined value such as a third positive value;
Block 5: the falling time control circuit 150, arranged to control the first I_{L} falling time (A*T_{OFF,DCM}) of the waveform, for example, the falling time control circuit 150 can generate the first I_{L} falling time (A*T_{OFF,DCM}), with the first I_{L} falling time (A*T_{OFF,DCM}) being proportional to the current I_{OFF,DCM}, and more particularly, control a second-level time period of a second level (e.g., the low level) of the control signal PWM, for controlling the first I_{L} falling time (A*T_{OFF,DCM}) of the waveform of the inductor current I_{L}, where “A” can be equal to the second predetermined value such as the second positive value; and
Block 6: the pulse-width modulation control circuit 160, referred to as the PWM control circuit 160 hereinafter for brevity, arranged to generate and output the control signal PWM (or “the PWM signal”) regarding the multi-pulse control to the driver 11, for performing the multi-pulse control on the buck converter 10, for example, the PWM control circuit 160 can generate the control signal PWM according to at least the first I_{L} rising time (T_{ON,DCM}), the first I_{L} falling time (A*T_{OFF,DCM}) and the second I_{L} rising time (A*T_{ON,DCM}), to make the control signal PWM have the waveform corresponding to the associated parameters as shown in FIG. 5;
where Blocks 1, 2, 3, 4, 5 and 6 can be implemented by way of at least one active component (e.g., one or more current sources), at least one passive component (e.g., one or more resistors) and/or at least one logic circuit (e.g., one or more logic gates), but the present invention is not limited thereto. As long as the implementation of the present invention will not be hindered, Blocks 1, 2, 3, 4, 5 and 6 can be implemented with various kinds of circuitry. In addition, the multiple sub-circuits of the multi-pulse control circuit 100 may further comprise multiple switches such as the switches SW1 and SW2.

As shown in FIG. 6, the switch SW1 can be arranged to selectively connect Block 2 such as the on time current gain circuit 120 and Block 3 such as the rising time control circuit 130, to allow the current I_{ON,DCM} to be transmitted from the on time current gain circuit 120 to the rising time control circuit 130 as illustrated with the rightward arrow depicted with dashed lines, and the switch SW2 can be arranged to selectively connect Block 2 such as the on time current gain circuit 120 and Block 4 such as the off time current gain circuit 140, to allow the current I_{ON,DCM} to be transmitted from the on time current gain circuit 120 to the off time current gain circuit 140 as illustrated with the downward arrow depicted with dashed lines. For example, the multi-pulse control circuit 100 can control the selective connection of any switch among the switches SW1 and SW2, and the associated operations may comprise:
(1) when the buck converter 10 needs to source the load current, the switch SW1 will be turned on and the switch SW2 will be turned off, and the rising time control circuit 130 generates a signal for controlling the first I_{L} rising time (T_{ON,DCM});
(2) after the first I_{L} rising time (T_{ON,DCM}) is over, the switch SW1 will be turned off and the switch SW2 will be turned on, the off time current gain circuit 140 applies the I_{OFF,DCM} current gain (e.g., (K/A)) to the current I_{ON,DCM} for generating the current I_{OFF,DCM}, and the falling time control circuit 150 generates a signal for controlling the first I_{L} falling time (A*T_{OFF,DCM});
(3) after the first I_{L} falling time (A*T_{OFF,DCM}) is over, the switch SW1 will be turned on and the switch SW2 will be turned off, and the rising time control circuit 130 generates a signal for controlling the second I_{L} rising time (A*T_{ON,DCM}); and
(4) lastly, when the second I_{L} rising time (A*T_{ON,DCM}) is over, both of the switches SW1 and SW2 will be turned off, and the inductor current I_{L} will fall until it crosses to the zero current and stops by the zero current detector 13.

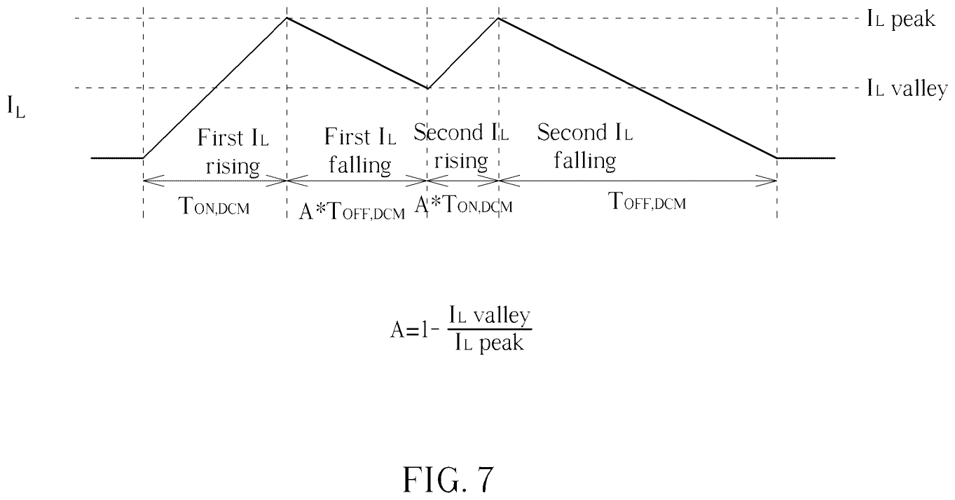

FIG. 7 is a diagram illustrating a peak and valley timing control scheme of the method according to an embodiment of the present invention. The current waveform of the inductor 12 in the buck converter 10 under the multi-pulse control, such as the waveform of the inductor current I_{L}, exhibits multiple peaks, and more particularly, these peaks may include two equal peaks. For better comprehension, the I_{L} peak means the peak current of the inductor 12, such as the peak of the inductor current I_{L} as shown in the curve thereof, and the I_{L} valley means the valley current of the inductor 12, such as the valley of the inductor current I_{L} as shown in the curve thereof. In addition, the current in the valley between the two peaks is equal to or greater than zero but smaller than the I_{L} peak. As shown in FIG. 7, the first I_{L} rising time such as T_{ON,DCM} means the time required for the inductor's current such as the inductor current I_{L} to rise from the zero current to the I_{L} peak, the first I_{L} falling time such as A*T_{OFF,DCM} means the time required for the inductor's current such as the inductor current I_{L} to fall from the I_{L} peak to the I_{L} valley, the second I_{L} rising time such as A*T_{ON,DCM} means the time required for the inductor's current such as the inductor current I_{L} to rise from the I_{L} valley to the I_{L} peak, and the second I_{L} falling time such as T_{OFF,DCM} means the time required for the inductor's current such as the inductor current I_{L} to fall from the I_{L} peak to the zero current. Regarding the parameters (A*T_{OFF,DCM}) and (A*T_{ON,DCM}), the parameter A embedded therein can be equal to one minus the division result obtained from dividing the I_{L} valley by the I_{L} peak, and therefore can be expressed as follows:

$$A = 1 - \frac{{I}_{L} valley}{{I}_{L} peak} .$$

Additionally, among the associated parameters in the embodiments shown in FIG. 5 to FIG. 7, the “DCM” in the subscripts of some parameters (e.g., T_{ON,DCM}, (A*T_{OFF,DCM}), (A*T_{ON,DCM}), T_{OFF,DCM}, I_{ON,DCM} and I_{OFF,DCM}) means the inductor 12 is in the discontinuous conduction mode (DCM).

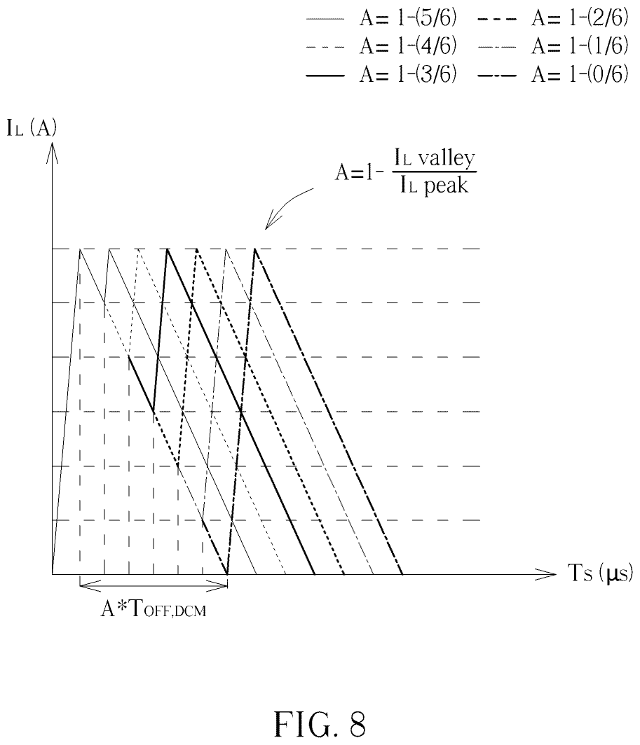

FIG. 8 is a diagram illustrating some implementation details of the peak and valley timing control scheme shown in FIG. 8 according to an embodiment of the present invention, where the horizontal axis may represent the period Ts (e.g., the multi-pulse/double-peak occurrence period Ts) that is measured in unit of microsecond (labeled “Ts(μs)” for brevity), and the vertical axis may represent the inductor current I_{L} that is measured in unit of ampere (labeled “I_{L}(A)” for brevity). The parameter A of the parameters (A*T_{OFF,DCM}) and (A*T_{ON,DCM}) may vary to allow the parameters (A*T_{OFF,DCM}) and (A*T_{ON,DCM}) to vary correspondingly, for example, as illustrated with the vertical lines depicted with dashed lines below the curves shown in FIG. 8. For better comprehension, the cases of A=1−(5/6), A=1−(4/6), A=1−(3/6), A=1−(2/6), A=1−(1/6) and A=1−(0/6) can be illustrated in FIG. 8, but the present invention is not limited thereto. More cases regarding other values of the parameter A can be further illustrated in FIG. 8.

The buck converter 10 (or the multi-pulse control circuit 100 therein) operating according to the method can control the value of the I_{L} valley by adjusting the parameter A. For example, the parameter A is controlled by the off time current gain circuit 140, which affects the first I_{L} falling time (A*T_{OFF,DCM}) by controlling the I_{OFF,DCM} current gain (e.g., (K/A)). The parameter A can also be used for controlling the second I_{L} rising time (A*T_{ON,DCM}) by adjusting I_{ON,DCM} using the rising time control circuit 130, ultimately achieving consistent I_{L} peak values. With the controllable I_{L} valley and the two identical I_{L} peaks, the buck converter 10 (or the multi-pulse control circuit 100 therein) operating according to the method can more effectively control the ratio of the core loss and the switching loss, thereby achieving optimal conversion efficiency.

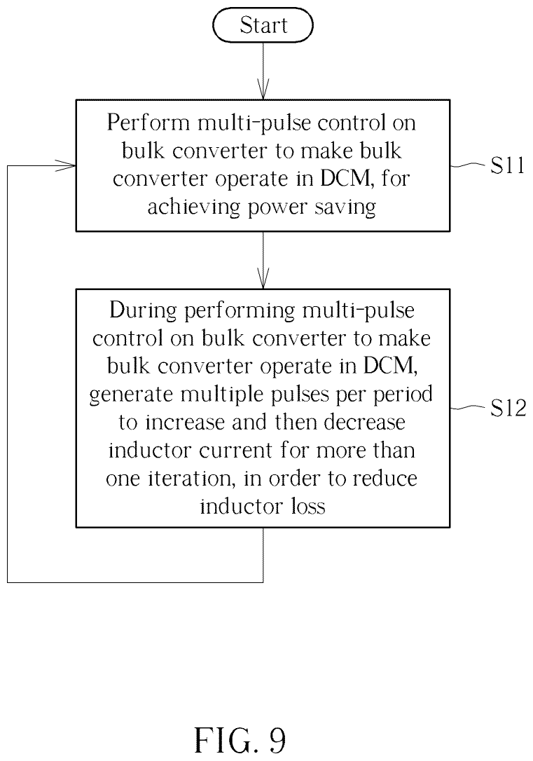

FIG. 9 is a flowchart of the method according to an embodiment of the present invention. The buck converter 10 and the multi-pulse control circuit 100 therein can operate according to the working flow shown in FIG. 9.

In Step S11, the multi-pulse control circuit 100 can start performing the multi-pulse control on the buck converter 10 to make the bulk converter 10 operate in the DCM, for achieving the power saving, in particular, for achieving the power saving as the reduction in the core loss exceeds the increase in the on/off switching loss of the aforementioned at least one switching device (e.g., the multiple switching devices MHS and MLS) within the buck converter 10.

In Step S12, during performing the multi-pulse control on the buck converter 10 to make the bulk converter 10 operate in the DCM, the multi-pulse control circuit 100 can generate multiple pulses per period on the control signal PWM (e.g., the extraordinary pulse-width modulation signal having more than one pulse per period) for controlling the bulk converter 10, to increase and then decrease the inductor current I_{L} of the inductor 12 within the bulk converter 10 for more than one iteration per period (e.g., the period Ts) before reaching the zero current (e.g., the inductor current value which is equal to zero), in order to reduce the inductor loss.

For better comprehension, the method may be illustrated with the working flow shown in FIG. 9, but the present invention is not limited thereto. According to some embodiments, one or more steps may be added, deleted, or changed in the working flow shown in FIG. 9.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing discontinuous conduction mode (DCM) pulse control of a buck converter to reduce inductor loss, comprising:
performing multi-pulse control on the buck converter to make the bulk converter operate in a DCM; and
during performing the multi-pulse control on the buck converter to make the bulk converter operate in the DCM, generating multiple pulses per period to increase and then decrease an inductor current of an inductor within the bulk converter for more than one iteration, in order to reduce the inductor loss.

2. The method of claim 1, wherein the performing the multi-pulse control on the buck converter to make the bulk converter operate in the DCM further comprises:
performing the multi-pulse control on the buck converter to make the bulk converter operate in the DCM, for achieving power saving as reduction in core loss exceeds increase in on/off switching loss of at least one switching device within the buck converter.

3. The method of claim 1, wherein in any period among multiple periods of the inductor current, the inductor current comprises a controllable inductor current valley and two identical inductor current peaks, wherein the controllable inductor current valley is between the two identical inductor current peaks.

4. The method of claim 3, wherein the controllable inductor current valley is equal to or greater than zero but smaller than any inductor current peak among the two identical inductor current peaks.

5. The method of claim 3, wherein with the controllable inductor current valley and the two identical inductor current peaks, the multi-pulse control effectively controls a ratio of core loss and switching loss of the buck converter.

6. The method of claim 1, wherein in any period among multiple periods of the inductor current, the inductor current comprises at least two inductor current peaks and at least one inductor current valley.

7. The method of claim 6, wherein all inductor current peaks among the at least two inductor current peaks are identical to each other.

8. The method of claim 6, wherein an inductor current valley between any two inductor current peaks among the at least two inductor current peaks is greater than zero, and is less than any inductor current peak in the at least two inductor current peaks.

9. An apparatus for performing discontinuous conduction mode (DCM) pulse control of a buck converter to reduce inductor loss, the apparatus comprising:
a multi-pulse control circuit, arranged to perform multi-pulse control on the buck converter to make the bulk converter operate in a DCM;
wherein:
during performing the multi-pulse control on the buck converter to make the bulk converter operate in the DCM, the multi-pulse control circuit is arranged to generate multiple pulses per period to increase and then decrease an inductor current of an inductor within the bulk converter for more than one iteration, in order to reduce the inductor loss.

10. The apparatus of claim 9, wherein the multi-pulse control circuit is arranged to perform the multi-pulse control on the buck converter to make the bulk converter operate in the DCM, for achieving power saving as reduction in core loss exceeds increase in on/off switching loss of at least one switching device within the buck converter.

11. The apparatus of claim 9, wherein in any period among multiple periods of the inductor current, the inductor current comprises a controllable inductor current valley and two identical inductor current peaks, wherein the controllable inductor current valley is between the two identical inductor current peaks.

12. The apparatus of claim 11, wherein the controllable inductor current valley is equal to or greater than zero but smaller than any inductor current peak among the two identical inductor current peaks.

13. The apparatus of claim 11, wherein with the controllable inductor current valley and the two identical inductor current peaks, the multi-pulse control effectively controls a ratio of core loss and switching loss of the buck converter.

14. The apparatus of claim 9, wherein in any period among multiple periods of the inductor current, the inductor current comprises at least two inductor current peaks and at least one inductor current valley.

15. The apparatus of claim 14, wherein all inductor current peaks among the at least two inductor current peaks are identical to each other.

16. The apparatus of claim 14, wherein an inductor current valley between any two inductor current peaks among the at least two inductor current peaks is greater than zero, and is less than any inductor current peak in the at least two inductor current peaks.

17. The apparatus of claim 9, wherein the multi-pulse control circuit comprises:
a voltage to current converter, arranged to generate a first current corresponding to an input voltage of the buck converter;
an on time current gain circuit, coupled to the voltage to current converter, arranged to convert the first current into a second current in accordance with an on time current gain;
a rising time control circuit, coupled to the on time current gain circuit, arranged to control a first inductor-current rising time and a second inductor-current rising time of a waveform of the inductor current according to the second current;
an off time current gain circuit, coupled to the on time current gain circuit, arranged to convert the second current into a third current in accordance with an off time current gain; and
a falling time control circuit, coupled to the off time current gain circuit, arranged to control a first inductor-current falling time of the waveform of the inductor current according to the third current.

18. The apparatus of claim 17, wherein a control signal regarding the multi-pulse control is used for controlling the bulk converter; the rising time control circuit is arranged to control one first-level time period and another first-level time period of a first level of the control signal, respectively, for controlling the first inductor-current rising time and the second inductor-current rising time of the waveform of the inductor current, respectively; and the falling time control circuit is arranged to control a second-level time period of a second level of the control signal, for controlling the first inductor-current falling time of the waveform of the inductor current.

19. The apparatus of claim 17, wherein the multi-pulse control circuit further comprises:
a pulse-width modulation control circuit, coupled to the rising time control circuit and the falling time control circuit, arranged to generate the control signal, for performing the multi-pulse control on the buck converter.

20. The apparatus of claim 9, wherein the apparatus comprises the buck converter, and the multi-pulse control circuit is integrated into the buck converter.
